(19) United States
(12) Patent Application Publication
(10) Pub. No.: US 2025/0055582 A1
(43) Pub. Date: Feb. 13, 2025

(54) L1-RSRP Measurement Delay for Group-Based Beam Reporting

(71) Applicant: Apple Inc., Cupertino, CA (US)

(72) Inventors: Xiang Chen, Campbell, CA (US); Dawei Zhang, Saratoga, CA (US); Haitong Sun, Saratoga, CA (US); Jie Cui, San Jose, CA (US); Konstantinos Sarrigeorgidis, Los Gatos, CA (US); Manasa Raghavan, Sunnyvale, CA (US); Yang Tang, San Jose, CA (US)

(21) Appl. No.: 18/798,441

(22) Filed: Aug. 8, 2024

Related U.S. Application Data
(60) Provisional application No. 63/518,464, filed on Aug. 9, 2023.

(51) Int. Cl. H04B 17/318; H04B 7/06; H04W 24/10

(52) U.S. Cl. CPC H04B 17/328; H04B 7/0626; H04W 24/10

(57) ABSTRACT

The present application relates to an improved method of operating a user equipment (UE), comprising: receiving, at the UE, a configuration of at least a first Channel Measurement Resource (CMR) set and a second CMR set for group-based beam reporting (GBBR) and performing, at the UE with at least a first antenna panel (and possibly multiple antenna panels), a first plurality of intracell, multiple TRP, Layer 1 Reference Signal Received Power (L1-RSRP) measurements. The first CMR set and second CMR set each comprises a plurality of resources (e.g., Synchronization Signal Block (SSB) resources and/or Channel State Information Reference Signal (CSI-RS) resources), and performing the first plurality of L1-RSRP measurements comprises performing a measurement using a number of fine beams (formed by one or more antenna panels) for one or more of the plurality of resources (up to and including each of the resources) in the first and second CMR sets.

### TECHNICAL FIELD

The present application relates to wireless devices and wireless networks, including user devices, terminals, circuits, computer-readable media, and methods for performing Layer 1 Reference Signal Received Power (L1-RSRP) measurements for group-based beam reporting (GBBR).

### BACKGROUND

Wireless communication systems are rapidly growing in usage. In recent years, wireless devices such as smart phones and tablet computers have become increasingly sophisticated. In addition to supporting telephone calls, many mobile devices now provide access to the Internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), Long-Term Evolution (LTE), LTE Advanced (LTE-A), HSPA, 3GPP2 CDMA2000 (e.g., 1×RTT, 1xEV-DO, HRPD, eHRPD), IEEE 802.11 (WLAN or Wi-Fi), and BLUETOOTH™, among others.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including the fifth generation (5G) standard and New Radio (NR) communication technologies and beyond. Accordingly, improvements in the field in support of such development and design are desired.

In Release-18 (R18), there is interest in researching multi-receive (multi-RX) chain downlink (DL) reception in the NR frequency range 2 (FR2). In particular, it is desired that enhanced UEs operating in the FR2-1 frequency range with simultaneous DL reception from different directions (e.g., with different quasi-co-located (QCL)-Type D reference signals on a single component carrier) achieve improved L1-RSRP measurement delay times.

Thus, improvements have been proposed herein to provide techniques for improved GBBR L1-RSRP measurements, especially in intracell, multi-TRP environments using only a single RX antenna panel at a time for the L1 measurements.

### SUMMARY

In accordance with one or more embodiments, a method of operating a user equipment (UE) is disclosed herein, the method comprising: receiving, at the UE, a configuration of at least a first Channel Measurement Resource (CMR) set and a second CMR set for group-based beam reporting (GBBR); and performing, at the UE with at least a first antenna panel, a first plurality of Layer 1 Reference Signal Received Power (L1-RSRP) measurements, wherein each of the first CMR set and second CMR set comprises a plurality of resources, and wherein performing the first plurality of L1-RSRP measurements comprises: performing a measurement using each of a number, n1, of fine beams for one or more of the plurality of resources in the first CMR set; and performing a measurement using each of a number, n2, of fine beams for one or more of the plurality of resources in the second CMR set.

According to some aspects, each of the integer numbers, n1 and n2, may be set to a number less than or equal to a beam sweeping factor value, N (and n1 and n2 do not necessarily need to be set to an equal value or be reflective of the same set of fine beams).

According to some aspects, at least one of the first plurality of L1-RSRP measurements are performed with a second antenna panel. For example, the performance of the first plurality of L1-RSRP measurements may be done: all by a first antennal panel, all by a second antenna panel, and/or by a combination of a first and a second panel (with no requirement that beams formed by a particular antenna panel may only be used to test the resources of a particular CMR set). In some aspects, the beams are tested one at a time, i.e., in a serial order.

According to some aspects, the first CMR set and second CMR set comprise Synchronization Signal Block (SSB) resource sets, wherein, e.g., the first CMR set and second CMR set are non-overlapping in time.

According to some aspects, performing the first plurality of L1-RSRP measurements further comprises: performing a measurement using each of the n1 fine beams for each of the plurality of resources in the first CMR set; and performing a measurement using each of the n2 fine beams for each of the plurality of resources in the second CMR set.

According to some aspects, the n1 fine beams are the same number of beams (though not necessarily the same exact beams) as the n2 fine beams.

According to some aspects, the first CMR set is associated with a first Transmission and Reception Point (TRP) and the second CMR set is associated with a second TRP, wherein, e.g., the first TRP and second TRP in within a same cell.

According to other aspects, performing the first plurality of L1-RSRP measurements further comprises: performing a measurement using each of the n1 fine beams for one of the resources in the first CMR set; and performing a measurement using each of the n2 fine beams for one of the resources in the second CMR set.

According to some such aspects, for at least one of the n1 fine beams, the method comprises: performing a measurement using the at least one n1 fine beam for each of the resources in the second CMR set; and for at least one of the n2 fine beams, performing a measurement using the at least one n2 fine beam for each of the resources in the first CMR set.

According to some aspects, the first CMR set and second CMR set comprise Channel State Information Reference Signal (CSI-RS) resource sets, wherein, e.g., the first CMR set and second CMR set are non-overlapping in time, partially overlapping in time, or fully overlapping in time. According to some such aspects, the first CMR set and second CMR set are scheduled periodically or semi-persistently (i.e., they are not scheduled aperiodically).

According to other such aspects, performing the first plurality of L1-RSRP measurements further comprises: performing a measurement using each of the n1 fine beams for each of the plurality of resources in the first CSI-RS CMR set; and performing a measurement using each of the n2 fine beams for each of the plurality of resources in the second CSI-RS CMR set. According to some such aspects, the n1 fine beams are the same number of beams (though not necessarily the same exact beams) as the n2 fine beams.

According to some such aspects, performing the first plurality of L1-RSRP measurements further comprises: performing a measurement using each of the n1 fine beams for one of the resources in the first CSI-RS CMR set; and performing a measurement using each of the n2 fine beams for one of the resources in the second CSI-RS CMR set.

According to some aspects, the method may further comprise: for at least one of the n1 fine beams (e.g., a fine beam that measured the highest signal strength for one of the resources in the first CMR set), performing a measurement using the at least one n1 fine beam for each of the resources in the second CMR set; and for at least one of the n2 fine beams (e.g., a fine beam that measured the highest signal strength for one of the resources in the second CMR set), performing a measurement using the at least one n2 fine beam for each of the resources in the first CMR set.

According to some aspects, the values of n1 and n2 are determined based, at least in part, on a number of Orthogonal Frequency Division Multiplexing (OFDM) symbols that are overlapping in time between the first CSI-RS CMR set and the second CSI-RS CMR set. According to some such aspects, the beam measurements are not performed in at least one of the first CMR set and the second CMR set during the OFDM symbols that are overlapping in time between the first CMR set and the second CMR set. According so some such aspects, the OFDM symbols overlapping in time between the first CMR set and the second CMR set during which measurements are not performed are evenly divided between the first CMR set and the second CMR set.

According to some aspects, the UE may receive a configuration from a network, wherein the configuration indicates a configuration for performing the first plurality of L1-RSRP measurements by the UE.

According to some aspects, each of the resources in the first CMR set and/or the second CMR set are measured using at least one of the n1 or n2 fine beams.

The various methods and techniques summarized in this section may likewise be performed by a UE device comprising: a receiver; a transmitter; and a processor configured to perform any of the various methods and techniques summarized herein. The various methods and techniques summarized in this section may likewise be stored as instructions in a non-volatile computer-readable medium, wherein the instructions, when executed, cause the performance of the various methods and techniques summarized herein.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter may be obtained when the following detailed description of various aspects is considered in conjunction with the following drawings:

FIG. 1 illustrates an example wireless communication system, according to some aspects.

FIG. 2 illustrates another example of a wireless communication system, according to some aspects.

FIG. 3 illustrates an example block diagram of a UE, according to some aspects.

FIG. 4 illustrates an example block diagram of a Base Station (BS), according to some aspects.

FIG. 5 illustrates a UE performing rough beam reporting in an exemplary multi-TRP, intracell environment, according to some aspects.

FIG. 6 illustrates a UE performing fine beam reporting in an exemplary multi-TRP, intracell environment, according to some aspects.

FIGS. 7A-7C illustrate methods of performing group-based beam reporting of SSB L1 measurements with improved measurement delays, according to some aspects.

FIG. 8 illustrates methods of performing group-based beam reporting of partially overlapping CSI-RS L1 measurements with improved measurement delays, according to some aspects.

FIG. 9 is a flowchart detailing a method of performing L1-RSRP measurements for group-based beam reporting, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

The present application relates to an improved method of operating a user equipment (UE), comprising: receiving, at the UE, a configuration of at least a first Channel Measurement Resource (CMR) set and a second CMR set for group-based beam reporting (GBBR) and performing, at the UE with at least a first antenna panel (and possibly multiple antenna panels), a first plurality of intracell, multiple TRP, Layer 1 Reference Signal Received Power (L1-RSRP) measurements. The first CMR set and second CMR set each comprises a plurality of resources (e.g., Synchronization Signal Block (SSB) resources and/or Channel State Information Reference Signal (CSI-RS) resources), and performing the first plurality of L1-RSRP measurements comprises performing a measurement using a number of fine beams (formed by one or more antenna panels) for one or more of the plurality of resources (up to and including each of the resources) in the first and second CMR sets.

The following is a glossary of additional terms that may be used in this disclosure:

Memory Medium—Any of various types of non-transitory memory devices or storage devices. The term “memory medium” is intended to include an installation medium, (e.g., a CD-ROM, floppy disks, or tape device; a computer system memory or random-access memory such as DRAM, DDR RAM, SRAM, EDO RAM, Rambus RAM), a non-volatile memory such as a Flash, magnetic media (e.g., a hard drive, or optical storage; registers, or other similar types of memory elements). The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations (e.g., in different computer systems that are connected over a network). The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”

User Equipment (UE) (also “User Device,” “UE Device,” or “Terminal”)—any of various types of computer systems or devices that are mobile or portable and that perform wireless communications. Examples of UE devices include mobile telephones or smart phones (e.g., iPhone™, Android™-based phones), portable gaming devices (e.g., Nintendo Switch™, Nintendo DS™, PlayStation Vita™, PlayStation Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, and the like. In general, the terms “UE” or “UE device” or “terminal” or “user device” may be broadly defined to encompass any electronic, computing, and/or telecommunications device (or combination of devices) that is easily transported by a user (or vehicle) and capable of wireless communication.

Wireless Device—any of various types of computer systems or devices that perform wireless communications. A wireless device may be portable (or mobile) or may be stationary or fixed at a certain location. A UE is an example of a wireless device.

Communication Device—any of various types of computer systems or devices that perform communications, where the communications may be wired or wireless. A communication device may be portable (or mobile) or may be stationary or fixed at a certain location. A wireless device is an example of a communication device. A UE is another example of a communication device.

Base Station—The terms “base station,” “wireless base station,” or “wireless station” have the full breadth of their ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB.’ If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” and the like, may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” and the like, are not intended to limit the concepts discussed herein to any particular wireless technology and the concepts discussed may be applied in any wireless system.

Node—The term “node,” or “wireless node” as used herein, may refer to one more apparatus associated with a cell that provide a wireless connection between user devices and a wired network generally.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an Application Specific Integrated Circuit (ASIC), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, and the like). For example, LTE may support scalable channel bandwidths from 1.4 MHz to 20 MHz. WLAN channels may be 22 MHz wide while Bluetooth channels may be 1 Mhz wide. Other protocols and standards may include different definitions of channels. Furthermore, some standards may define and use multiple types of channels (e.g., different channels for uplink or downlink and/or different channels for different uses such as data, control information, and the like).

Band—The term “band” has the full breadth of its ordinary meaning, and at least includes a section of spectrum (e.g., radio frequency spectrum) in which channels are used or set aside for the same purpose.

Configured to—Various components may be described as “configured to” perform a task or tasks. In such contexts, “configured to” is a broad recitation generally meaning “having structure that” performs the task or tasks during operation. As such, the component may be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component may be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Example Wireless Communication System

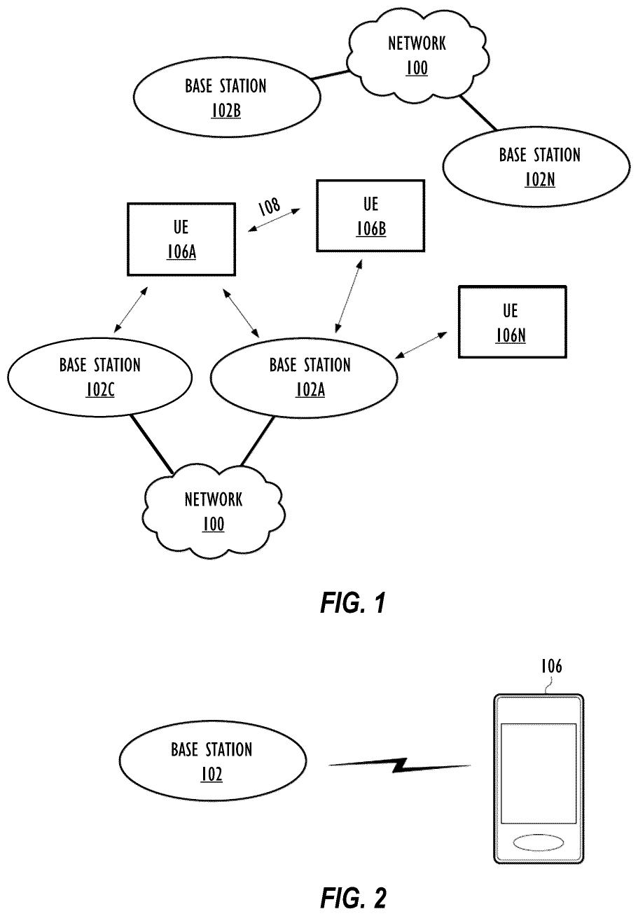

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106N. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2 CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using an SL interface for direct communications between devices. The IoT UEs may also execute background applications (e.g., keep-alive messages, status updates, and the like) to facilitate the connections of the IoT network.

As shown, the UEs 106, such as UE 106A and UE 106B, may directly exchange communication data via an SL interface 108. The SL interface 108 may be a PC5 interface comprising one or more physical channels, including but not limited to a Physical Sidelink Shared Channel (PSSCH), a Physical Sidelink Control Channel (PSCCH), a Physical Sidelink Broadcast Channel (PSBCH), and a Physical Sidelink Feedback Channel (PSFCH).

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (vUEs). The RSU may also include internal data storage circuitry to store intersection map geometry, traffic statistics, media, as well as applications/software to sense and control ongoing vehicular and pedestrian traffic. The RSU may operate on the 5.9 GHz Intelligent Transport Systems (ITS) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weather enclosure suitable for outdoor installation, and it may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS, and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106N and similar devices over a geographic area via one or more cellular communication standards.

Thus, while base station 102A may act as a “serving cell” for UEs 106A-106N as illustrated in FIG. 1, each UE 106 may also be capable of receiving signals from (and possibly within communication range of) one or more other cells (which may be provided by base stations 102B-102N and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102N may be a micro cell. Other configurations are also possible.

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to at least one of the cellular communication protocol discussed in the definitions above. The UE 106 may also or alternatively be configured to communicate using one or more global navigational satellite systems (GNSS) (e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

As illustrated in FIG. 2, in one or more embodiments, the UE 106 may be a device with cellular communication capability such as a mobile phone, a hand-held device, a computer, a laptop, a tablet, a smart watch, or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1×RTT/1xEV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a baseband processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1×RTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource selection. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1, 2, 4, or 8).

### Example Communication Device

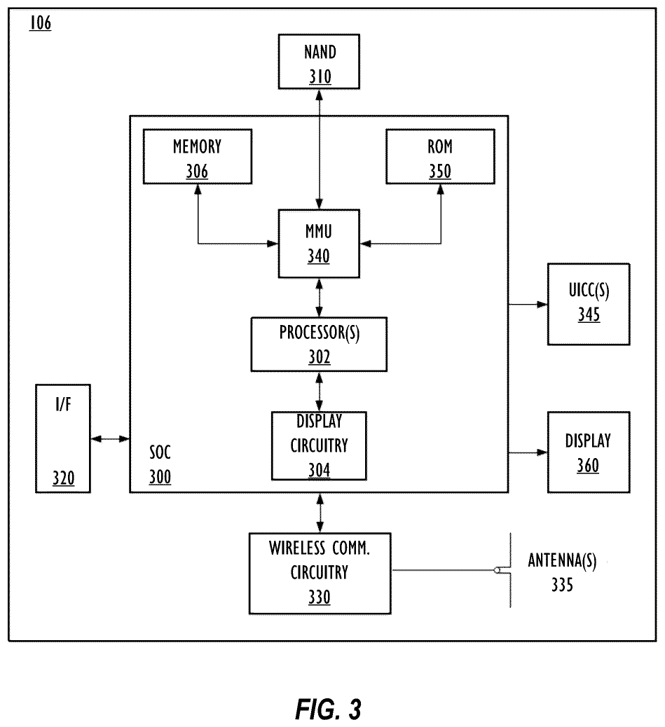

FIG. 3 illustrates an example simplified block diagram of a communication device 106, according to some aspects. It is noted that the block diagram of the communication device of FIG. 3 is only one example of a possible communication device. According to aspects, communication device 106 may be a UE device or terminal, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components configured to perform core functions. For example, this set of components may be implemented as a system on chip (SOC), which may include portions for various purposes. Alternatively, this set of components may be implemented as separate components or groups of components for the various purposes. The set of components may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; and the like), the display 360, which may be integrated with or external to the communication device 106, and wireless communication circuitry 330 (e.g., for LTE, LTE-A, NR, UMTS, GSM, CDMA2000, Bluetooth, Wi-Fi, NFC, GPS, and the like). In some aspects, communication device 106 may include wired communication circuitry (not shown), such as a network interface card (e.g., for Ethernet connection).

The wireless communication circuitry 330 may couple (e.g., communicatively; directly or indirectly) to one or more antennas, such as antenna(s) 335 (each of which may include an antenna panel), as shown. The wireless communication circuitry 330 may include cellular communication circuitry and/or short to medium range wireless communication circuitry and may include multiple receive chains and/or multiple transmit chains for receiving and/or transmitting multiple spatial streams, such as in a MIMO configuration.

In some aspects, as further described below, cellular communication circuitry 330 may include one or more receive chains (including and/or coupled to (e.g., communicatively; directly or indirectly) dedicated processors and/or radios) for multiple Radio Access Technologies (RATs) (e.g., a first receive chain for LTE and a second receive chain for 5G NR). In addition, in some aspects, cellular communication circuitry 330 may include a single transmit chain that may be switched between radios dedicated to specific RATs. For example, a first radio may be dedicated to a first RAT (e.g., LTE) and may be in communication with a dedicated receive chain and a transmit chain shared with a second radio. The second radio may be dedicated to a second RAT (e.g., 5G NR) and may be in communication with a dedicated receive chain and the shared transmit chain. In some aspects, the second RAT may operate at mmWave frequencies. As mmWave systems operate in higher frequencies than typically found in LTE systems, signals in the mm Wave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements.

The communication device 106 may further include one or more smart cards 345 that include Subscriber Identity Module (SIM) functionality, such as one or more Universal Integrated Circuit Card(s) (UICC(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some aspects, the MMU 340 may be included as a portion of the processor(s) 302.

As noted above, the communication device 106 may be configured to communicate using wireless and/or wired communication circuitry. As described herein, the communication device 106 may include hardware and software components for implementing any of the various features and techniques described herein. The processor 302 of the communication device 106 may be configured to implement part or all of the features described herein (e.g., by executing program instructions stored on a memory medium). Alternatively (or in addition), processor 302 may be configured as a programmable hardware element, such as a Field Programmable Gate Array (FPGA), or as an Application Specific Integrated Circuit (ASIC). Alternatively (or in addition) the processor 302 of the communication device 106, in conjunction with one or more of the other components 300, 304, 306, 310, 320, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, and the like) configured to perform the functions of processor(s) 302.

Further, as described herein, wireless communication circuitry 330 may include one or more processing elements. In other words, one or more processing elements may be included in wireless communication circuitry 330. Thus, wireless communication circuitry 330 may include one or more integrated circuits (ICs) that are configured to perform the functions of wireless communication circuitry 330. In addition, each integrated circuit may include circuitry (e.g., first circuitry, second circuitry, and the like) configured to perform the functions of wireless communication circuitry 330.

### Example Base Station

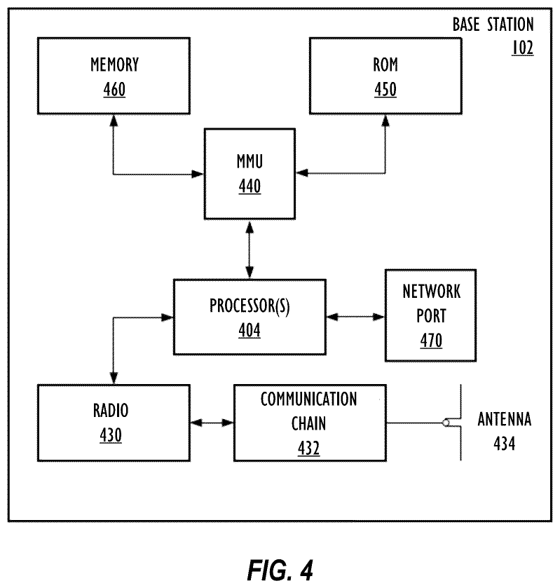

FIG. 4 illustrates an example block diagram of a base station 102, according to some aspects. It is noted that the base station of FIG. 4 is a non-limiting example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIG. 1.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some aspects, base station 102 may be a next generation base station, (e.g., a 5G New Radio (5G NR) base station, or “gNB”). In such aspects, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas or antenna panels. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including 5G NR, LTE, LTE-A, GSM, UMTS, CDMA2000, Wi-Fi, and the like.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. When the base station 102 supports mm Wave, the 5G NR radio may be coupled to one or more mmWave antenna arrays or panels. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, and the like).

Further, the BS 102 may include hardware and software components for implementing or supporting implementation of features described herein. The processor 404 of the base station 102 may be configured to implement or support implementation of part or all of the methods described herein (e.g., by executing program instructions stored on a memory medium). Alternatively, the processor 404 may be configured as a programmable hardware element, such as a Field Programmable Gate Array (FPGA), or as an Application Specific Integrated Circuit (ASIC), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, and the like) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, and the like) configured to perform the functions of radio 430.

### Multiple-Transmission and Reception Point (mTRP) Communications

As used herein, multiple transmission and reception point (mTRP) communications refers to a 5G technologies enabling gNodeB (gNB) base stations to use more than one transmission and reception point (i.e., TRP) to communicate with user equipment (UE) devices. The usage of mTRP cellular environments helps carriers to both optimize their network performance and increase network robustness, especially near cell edges. The technology behind mTRP also provides the framework for 5G millimeter wave (mmWave) performance optimization.

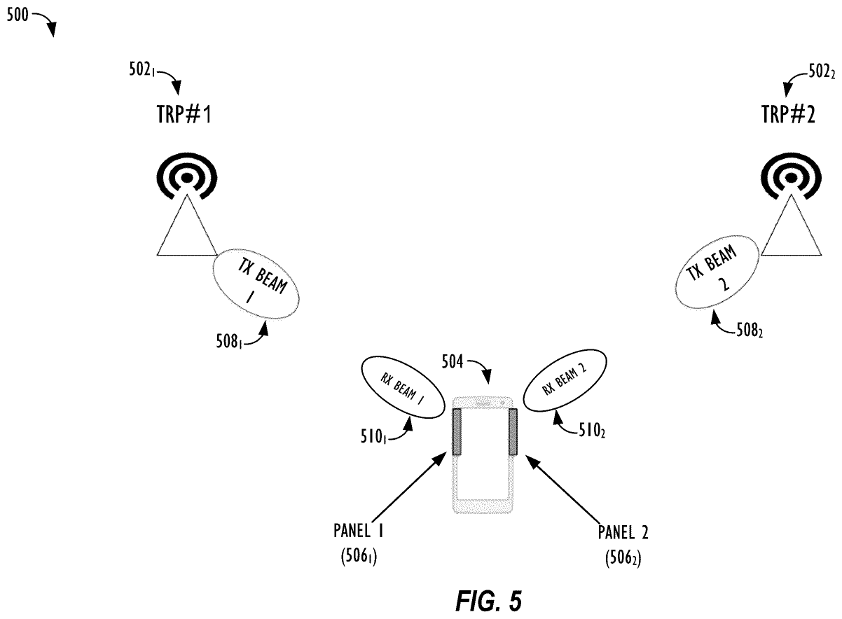

Turning now to FIG. 5, a diagram 500 illustrating a UE performing rough beam reporting in an exemplary multi-TRP, intracell environment is shown, according to some aspects. Specifically, diagram 500 illustrates mTRP communication between TRP 1 502₁ and a UE 504, as well as between TRP 2 502₂ and the UE 504. The UE 504 is illustrated with a panel on each side (e.g., Panel #1 506₁ and Panel #2 506₂), wherein each panel may have one or more transceivers capable of beam management (BM), in accordance with current beamforming and MIMO techniques.

In accordance with the techniques and embodiments herein, TRP 1 502₁ may determine to communicate with the UE 504 via a first transmission beam (e.g., TX Beam #1 508₁), while UE 504 may determine to communicate with the TRP 1 502₁ via a first reception beam (e.g., RX Beam #1 510₁). In some instances, the choice of which beam to use for reception (and/or transmission) may be based on which beam measures the highest signal strength in a received reference signal, as will be described in greater detail herein.

Returning to FIG. 5, similarly, TRP 2 502₂, which is within the same cell as TRP 1 502₁, may determine to communicate with the UE 504 via a second transmission beam (e.g., TX Beam #2 508₂), while UE 504 may determine to communicate with the TRP 2 502₂ via a second reception beam (e.g., RX Beam #2 510₂). According to some embodiments disclosed herein, the UE 504 may only perform L1-RSRP measurements with a single RX panel (e.g., Panel #1 506₁ or Panel #2 506₂) at a time, although the entire set of beams that are tested and reported in a given beam report may be formed by multiple RX panels over time, if so desired.

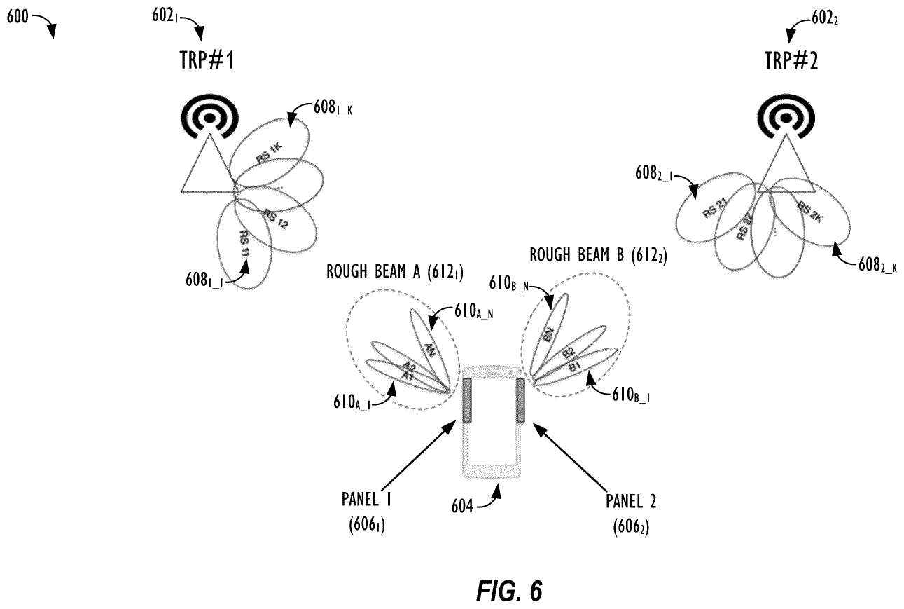

Turning now to FIG. 6, a diagram 600 illustrating a UE performing fine beam reporting in an exemplary multi-TRP, intracell environment is shown, according to some aspects. Similar to the environment described above with reference to FIG. 5, diagram 600 illustrates mTRP communication between TRP 1 602₁ and a UE 604, as well as between TRP 2 602₂ and the UE 604. The UE 604 is illustrated with a panel on each side (e.g., Panel #1 606₁ and Panel #2 606₂), wherein each panel may have one or more transceivers capable of BM. In accordance with the techniques and embodiments herein, TRP 1 602₁ may determine to communicate with the UE 604 via a first transmission beam, which may transmit a plurality of ‘K’ reference signals 608_{1_1}-608_{1_K}, while UE 604 may determine to communicate with the TRP 1 602₁ via a first rough reception beam (e.g., RX Rough Beam A 612₁). Within a given rough beam (e.g., 612₁), the UE 604 may further determine which of a plurality of ‘N’ fine beams (e.g., fine beams 610_{A_1}-610_{A_N}) to use for the reception.

Similarly, TRP 2 602₂ may determine to communicate with the UE 604 via a second transmission beam, which may transmit a plurality of ‘K’ reference signals 608_{2_1}-608_{2_K}, while UE 604 may determine to communicate with the TRP 2 602₂ via a second rough reception beam (e.g., RX Rough Beam B 612₂). Within a given rough beam (e.g., 612₂), the UE 604 may further determine which of a plurality of ‘N’ fine beams (e.g., fine beams 610_{B_1}-610_{B_N}) to use for the reception.

As used herein, for each of the K resources in a CMR set, a UE is allowed to test up to N fine beams, denoted herein using the notation of: Beam_k_1, Beam_k_2, . . . , Beam_k_N. Note that, in some embodiments, the N fine beams to be tested for a first resource in a CMR set (e.g., SSB #1) could be different from the N fine beams to be tested for a second resource in the CMR set (e.g., SSB #2), hence beams with the notation of Beam_1_1 and Beam_2_1 could refer to different fine beams that are formed by the UE. For example, the resources in the first CMR set could be measured by a first number, n1, of fine beams, while the resources in the second CMR set could be measured by a second number, n2, of fine beams. According to some aspects, the values of the integers n1 and n2 do not necessarily need to be equal and, even if the values of n1 and n2 are equal, they do no need to refer to the same fine beams formed by the UE. In fact, the beams formed by a UE during any GBBR measurement may be formed by any combination of a first antenna panel and a second antenna panel (and/or any additional antenna panels if a UE is so equipped).

Moreover, even though they are both illustrated as having ‘K’ resources herein for convenience and ease of illustration, according to some implementations, a first CMR set and a second CMR set need not have the same number (e.g., ‘K’) of resources as each other.

### Group-Based Beam Reporting (GBBR) of L1-RSRP Measurements of Synchronization Signal Block (SSB) Resource Sets for Intra-Cell mTRP Communications

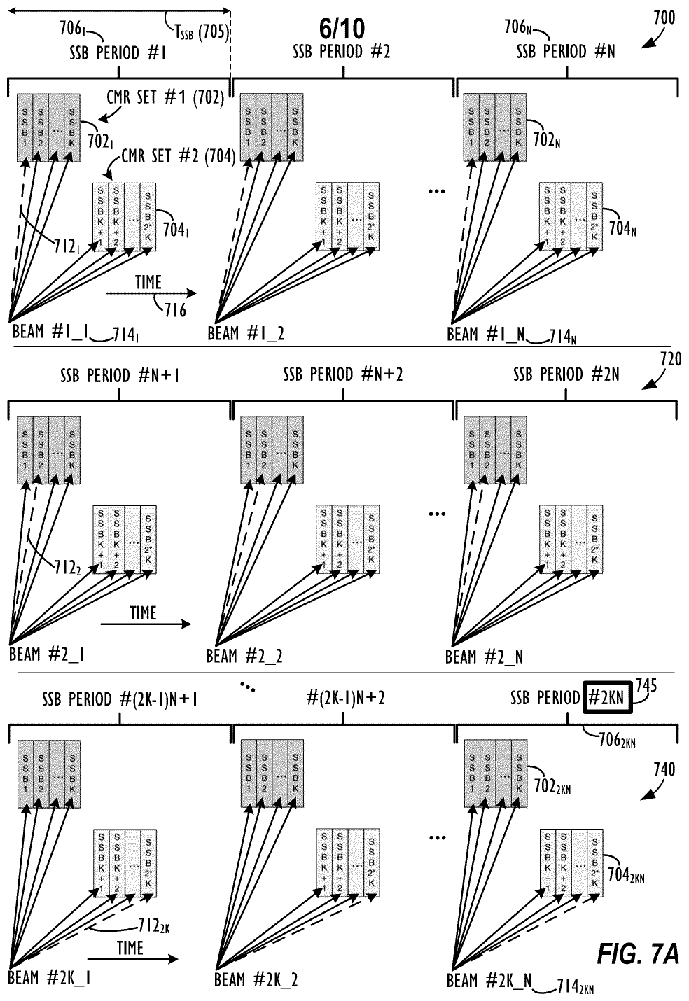

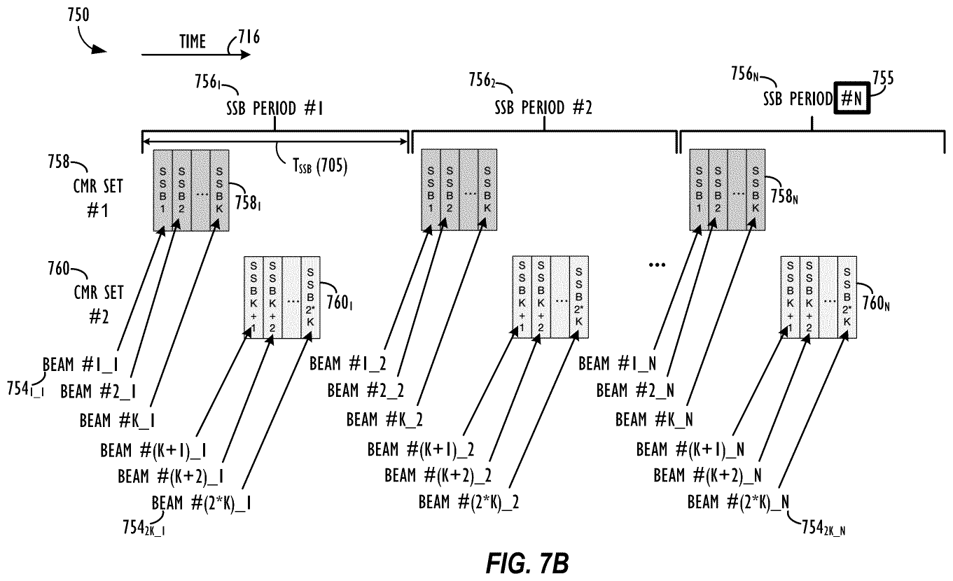

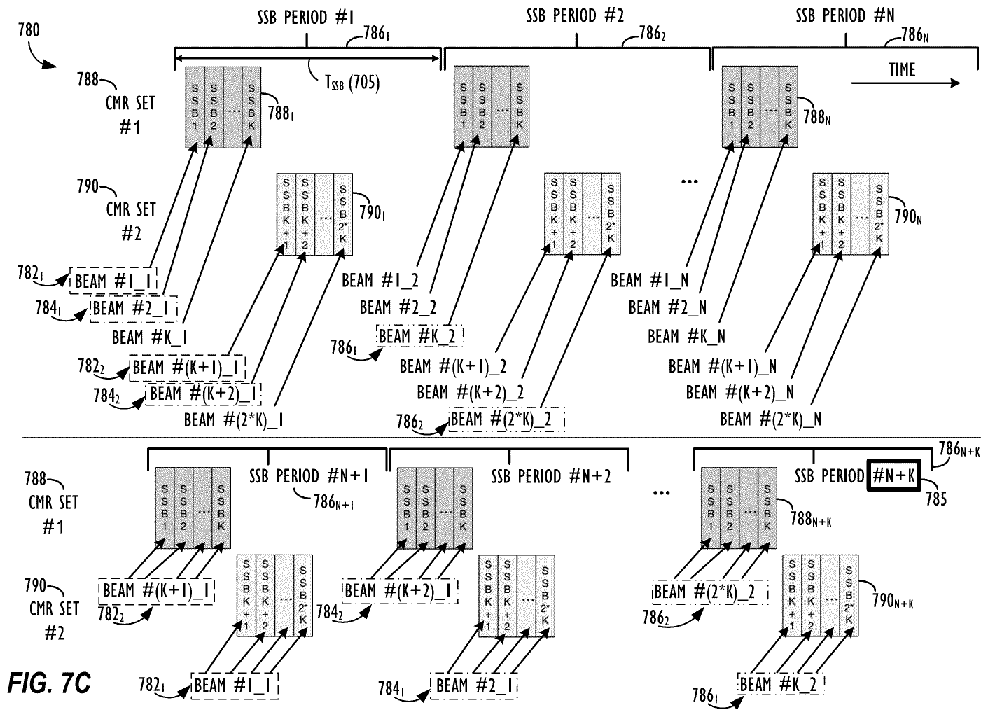

Turning now to FIGS. 7A-7C, various diagrams detailing methods of performing group-based beam reporting of SSB L1 measurements with improved measurement delays are illustrated, according to some aspects. The examples illustrated in FIGS. 7A-7C show the measurement resources in the CMR sets as being Synchronization Signal Block (SSB) reference signals (though it is to be understood that other types of reference signals, e.g., CSI-RS, may also be utilized).

For group-based L1 beam measurements, it may be assumed that the measurement resources (also referred to herein as a “reference signal” or “RS”) that are to be measured may be initially configured based on previously made Layer 3 (L3) measurements. For the examples described herein, it will be assumed that the network configures two CMR sets for the UE to measure (referred to herein as CMR set #1 and CMR set #2), with each set having ‘K’ SSB resources. For a UE to refine its beam selection, a beam sweeping factor, ‘N’ (e.g., ‘N’=8), may be set. The UE is then allowed to test out up to N different fine beams for each RS that is to be measured.

Referring first to FIG. 7A, there is a first row 700 of N different SSB periods (i.e., SSB Period #1 706₁ up to SSB Period #N 706_{N}) illustrated. Each SSB period 706 has a duration in time along the horizontal time axis 716, as indicated by the SSB periodicity time, T_{SSB} 705. During each SSB period 706, the aforementioned first CMR set (i.e., CMR set #1 702 comprising SSB resources having indices labeled SSB₁ up to SSB_{K}) and second CMR set (i.e., CMR set #2 704 comprising SSB resources having indices labeled SSB_{K+1} up to SSB_{2K}) are broadcast by one or more TRPs. For example, CMR set #1 702 may be broadcast by a first TRP #1, and CMR set #2 704 may be broadcast by a second TRP #2.

In the exemplary L1 GBBR measurement scheme illustrated in FIG. 7A, for every SSB period 706, the UE will test one RX fine beam 714. This will help the UE to fully evaluate the interferences between CMR set #1 702 and CMR set #2 704. With a beam sweeping factor of N, and a total of K+K, or 2K, SSB resources to test across the two CMR sets, the total number of SSB periodicities needed under this scheme is, thus, 2*K*N, as shown by final SSB period #2KN (745) in row 740. In other words, the needed measurement period is 2*K*N*T_{SSB}, where T_{SSB} (705) is the periodicity of the SSB-Index configured for L1-RSRP measurement. As may now be appreciated, if the two CMR sets 702/704 have different numbers of SSB resources, e.g., CMR set #1 having a total of K_{CMR1} resources and CMR set #1 having a total of K_{CMR2} resources, then, rather than being 2*K*N*T_{SSB}, the measurement period may be represented by: (K_{CMR1}+K_{CMR2})*N*T_{SSB}.

Looking in more detail at the SSB Period #1 706₁, the particular beam 714₁ being tested is denoted as Beam #1_1. As explained above, using the notation of Beam_k_n, the Beam #1_1 (714₁) reflects a first fine beam (i.e., n=1) measuring the first RS (i.e., k=1 for SSB₁) in a first CMR set (702₁). In the measurement scheme of FIG. 7A, the UE only tests one fine beam for the entire SSB period. Thus, there is an arrow pointing from Beam #1_1 (714₁) to each of the K resources of CMR set #1 (702₁), as well as to each of the K resources of CMR set #2 (704₁). The dashed arrow line 712₁ pointing to SSB₁ indicates that, in SSB period #1 706₁, the Beam #1_1 (714₁) is being used to test the signal strength of the RS SSB1. The other arrows emanating from the Beam #1_1 (714₁) indicate that the beam is also being used to evaluate a full interference picture between Beam #1_1 (714₁) and the other 2K−1 resources of CMR set #1 702 and CMR set #2 704.

Following along row 700, the next beam to be tested is Beam #1_2. As explained above, during the second SSB period, the UE tests Beam #1_2 throughout the entire SSB period. This procedure is continued through the Nth SSB period (706_{N}), wherein the UE tests Beam #1_N (714_{N}) throughout the entire SSB period (706_{N}). As may now be appreciated, the above-referenced N SSB bursts are needed to test the N fine beams for SSB₁.

Moving down to row 720 in FIG. 7A, the next N SSB periods (i.e., SSB Period #N+1 through 2N) are needed to test the N fine beams for SSB₂ (as indicated by dashed arrow line 712₂ pointing to SSB₂), i.e., Beam #2_1, Beam #2_2, . . . , Beam #2_N.

As mentioned above, in this example, there are 2*K SSBs, so the number of total SSB periods needed for measurement are 2*K*N. Moving down to final row 740 in FIG. 7A, the final set of N SSB periods are illustrated, i.e., SSB Period #(2K−1)N+1 through 2KN (706_{2KN}), which are needed to test the N fine beams for SSB_{2K} (as indicated by dashed arrow line 712_{2K} pointing to SSB_{2K}), i.e., Beam #2K_1, Beam #2K_2, Beam #2K_N (714_{2KN}). [It is to be understood that, in the interests of clarity, one or more rows of N SSB periods have been excised from the FIG. 7A between the second row and the final (i.e., 2Kth) row of the diagram.]

As may now be appreciated, because the fine beams that are tested by the UE may come from any combination of one or more antenna panels, the scheme illustrated in FIG. 7A provides a full beam interference picture between the various panels, but also requires a longer measurement delay (i.e., 2*K*N SSB periods) than the other alternative embodiments, which will now be described in greater detail.

Referring next to FIG. 7B and diagram 750, an alternative measurement embodiment is illustrated, wherein, for every SSB in an SSB period (756), the UE will test one RX fine beam. This scheme will lead to a smaller measurement period than the scheme illustrated in FIG. 7A. In particular, the total number of SSB periodicities needed to test all of the N beams for each measurement resource will be N (755), i.e., the needed measurement period will be N*T_{SSB} (705).

As shown in diagram 750, a first SSB (SSB₁) in a first CMR set #1 (758₁) is tested by a first beam denoted Beam #1_1 (754_{1_1}). Next, the second SSB (SSB₂) is tested by a second beam denoted Beam #2_1, and so forth, until Beam #2K_1 (754_{2K_1}), such that each of the 2K RSs of first CMR set #1 (758₁) and first CMR set #2 (760₁) are tested by an RX fine beam.

In other words, for each SSB in a given SSB period (756), the UE changes the fine beam to be tested, i.e., the UE tests a total of 2*K fine beams per SSB period, since there are 2*K SSBs, in this example. Moving on to the second SSB period (756₂), the UE tests Beam #1_2 for SSB₁, Beam #2_2 for SSB₂, . . . , and Beam #2*K_2 for SSB_{2*K}. This process continues for up to N SSB periods (wherein, again, N is the beam sweeping factor), concluding with the Nth SSB burst (756_{N}), wherein the UE tests Beam #1_N for SSB₁, Beam #2_N for SSB₂, . . . , and Beam #2*K_N for SSB_{2*K}. Therefore, only N SSB periods are needed for the measurement scheme illustrated in FIG. 7B to test all of the N beams for each measurement resource.

As described above, the measurement scheme illustrated in FIG. 7A requires 2*K*N SSB periods (i.e., it is a longer delay than 2*N SSB periods), but it allows each tested fine beam for each SSB resource to be used for measuring other SSBs, and hence it gives the full interference picture. It is also noted that the fine beams for measuring each SSB can be formed by using a first antenna panel, a second antenna panel, any combination thereof and/or additional antenna panels if a UE is so equipped.

Referring next to FIG. 7C an exemplary “hybrid” measurement embodiment 780 is illustrated combining aspects of the measurement scheme of FIG. 7A with the measurement scheme of FIG. 7B, wherein, for every SSB in each of a first set of N SSB periods (i.e., 786₁ . . . 786_{N}), the UE will test one RX fine beam, mirroring the measurement scheme of FIG. 7B, described above. In total, the number of SSB periodicities needed to test all of the N beams will again be N. According to some such “hybrid” measurement embodiments, one or more additional SSB periods may then be used, e.g., to test the interference profile of some (but not all) of the beams, thereby resulting in an overall measurement delay that is somewhere between that of FIG. 7B (i.e., N*T_{SSB}) and that of FIG. 7A (i.e., 2*K*N*T_{SSB}).

According to the hybrid measurement scheme 780 of FIG. 7C, in the initial set of N SSB periods, a so-called “winning” beam may be determined (e.g., a beam measuring the largest RSRP) for each RS in CMR set #1 (788) and CMR set #2 (790). For example, as indicated by the dashed line boxes in FIG. 7C, the winning beam for SSB₁ was Beam #1_1 (782₁), and the winning beam for SSB_{K+1} was Beam #K+1_1 (782₂). Similarly, the winning beam for SSB₂ was Beam #2_1 (784₁), and the winning beam for SSB_{K+2} was Beam #K+2_1 (784₂). To complete the example, the winning beam for SSB_{K} was Beam #K_2 (786₁), and the winning beam for SSB_{2K} was Beam #2K_2 (786₂). It is to be understood that, although not illustrated, a corresponding pair of “winning” beams may be identified for each of the K pairs of RSs in CMR set #1 (788) and CMR set #2 (790) during the initial N SSB periods (i.e., 786₁ . . . 786_{N}).

Moving below the horizontal line in FIG. 7C, the next K SSB periods may then be spent developing a full interference picture for each of the K pairs of “wining” beams, in particular, by measuring the winning beam for CMR set #1 (788) against each of the SSBs in the other CMR set, i.e., CMR set #2 (790), and vice versa, i.e., measuring the winning beam for CMR set #2 (790) against each of the SSBs in CMR set #1 (788).

Turning now to SSB period #N+1 (786_{N+1}), it is illustrated that “winning” Beam #K+1_1 (782₂) from the first SSB (i.e., SSB_{K+1}) of CMR set #2 (790) is tested against each SSB of CMR set #1 (788), while the “winning” Beam #1_1 (782₁) from the first SSB (i.e., SSB₁) of CMR set #1 (788) is tested against each SSB of CMR set #2 (790), thereby providing a full interference picture for at least the respective pair of winning beams for the first SSBs in each CMR set. Moving forward to SSB period #N+2, it is similarly illustrated that “winning” Beam #K+2_1 (784₂) from the second SSB (i.e., SSB_{K+2}) of CMR set #2 (790) is tested against each SSB of CMR set #1 (788), while the “winning” Beam #2_1 (784₁) from the second SSB (i.e., SSB₂) of CMR set #1 (788) is tested against each SSB of CMR set #2 (790). This process may be repeated until finally, at SSB period #N+K (786_{N+K}), the “winning” Beam #2K_2 (786₂) from the Kth SSB (i.e., SSB_{2K}) of CMR set #2 (790) is tested against each SSB of CMR set #1 (788), while the “winning” Beam #K_2 (786₁) from the Kth SSB (i.e., SSB₂) of CMR set #1 (788) is tested against each SSB of CMR set #2 (790).

As may now be understood, this particular type of measurement scheme illustrated in FIG. 7C will result in N+K SSB periods (785) and an overall measurement delay of (N+K)*T_{SSB}, which, as described above, is between the delay of FIG. 7B (i.e., N*T_{SSB}) and the delay of FIG. 7A (i.e., 2*K*N*T_{SSB}) and provides some (although not comprehensive) interference information regarding the N beams.

### Group-Based Beam Reporting (GBBR) of L1-RSRP Measurements of Channel State Information Reference Signal (CSI-RS) Resource Sets for Intra-Cell mTRP Communications

In the case of GBBR of L1-RSRP measurements of CSI-RS resource sets (as opposed to SSB resource sets, as described above with reference to FIGS. 7A-7C), a network may again configure two CMR sets for the UE to measure, each set having K CSI-RS resources. For a UE to refine its beams, a suitable beam sweeping factor (e.g., N=8) may be selected, i.e., the UE would need to test out up to N different fine beams for each RS to be measured.

There are two use cases for CSI-RS, i.e., one where the higher layer parameter repetition is set to “OFF” and one where the higher layer parameter repetition set to “ON.” As with legacy requirements, when repetition is set to OFF, the beam sweeping factor is simply set to N=1. In other words, the UE knows which fine beam to use, and there is no need to perform beam sweeping. However, when repetition is set to ON, the beam sweeping factor N=ceil(maxNumberRxBeam/Nres_per_set), where maxNumberRxBeam can be considered as the maximum number of RX beams at the UE that need to be tested, Nres_per_set is number of resources in the resource set, and “ceil” is a ceiling function that rounds up the division result to the next highest integer value.

For the sake of the examples presented in this section, it may be assumed that the two CSI-RS sets (e.g., CMR set #1 and CMR set #2) have the same periodicity, denoted by T_{CSI-RS}. If they do not have the same periodicity, then the larger periodicity of the two sets may simply be denoted by T_{CSI-RS}.

Unlike SSBs which may not overlap in time during an SSB period, two CMR sets for CSI-RS resources may be: non-overlapping, partially overlapping, or fully overlapping in the time domain. In the case that there is no overlap in the time domain between the two CMR sets with repetition set to ON, then the possible measurement scheme solutions for CSI-RS resources essentially are analogous to the three embodiments for SSBs illustrated and described with respect to FIGS. 7A-7C, with the difference that K resources in each CMR set are transmitted using the same TX beam (i.e., the same spatial filter). In this case, the beam sweeping factor N may be set equal to ceil(maxNumberRxBeam/K).

In a first embodiment for measuring CSI-RS resources that provides a full interference picture, the total number of CSI-RS periodicities needed to completely the L1 measurement reporting is 2*N. In other words, the needed measurement period is 2*N*T_{CSI-RS}. (If the two CMR sets have different number of CSI-RS resources, say K_{CMR1} and K_{CMR2}, then the value of 2*N*T_{CSI-RS} is replaced by (N1+N2)*T_{CSI-RS}, where N1=ceil(maxNumberRxBeam/K_{CMR1}) and N2=ceil(maxNumberRxBeam/K_{CMR2})).

In a second embodiment for measuring CSI-RS resources that produces a minimal measurement delay but does not provide comprehensive interference information, the total number of CSI-RS periodicities needed to complete the measurement reporting is N, where N=ceil(maxNumberRxBeam/K).

In a third or hybrid embodiment, the total number of CSI-RS periodicities needed to complete the measurement reporting may be chosen to be a value between N and 2*N. Similar to the SSB case described above with reference to FIG. 7C, in an initial set of N CSI-RS periods, a so-called “winning” beam may be determined for both CMR set #1 and CMR set #2. Then the “winning” beam for CMR set #1 is tested against CSI-RS in CMR set #2, and the “winning” beam for CMR set #2 is tested against CSI-RS in CMR set #1, which would require one additional CSI-RS period, resulting in a total of N+1 CSI-RS periodicities being needed.

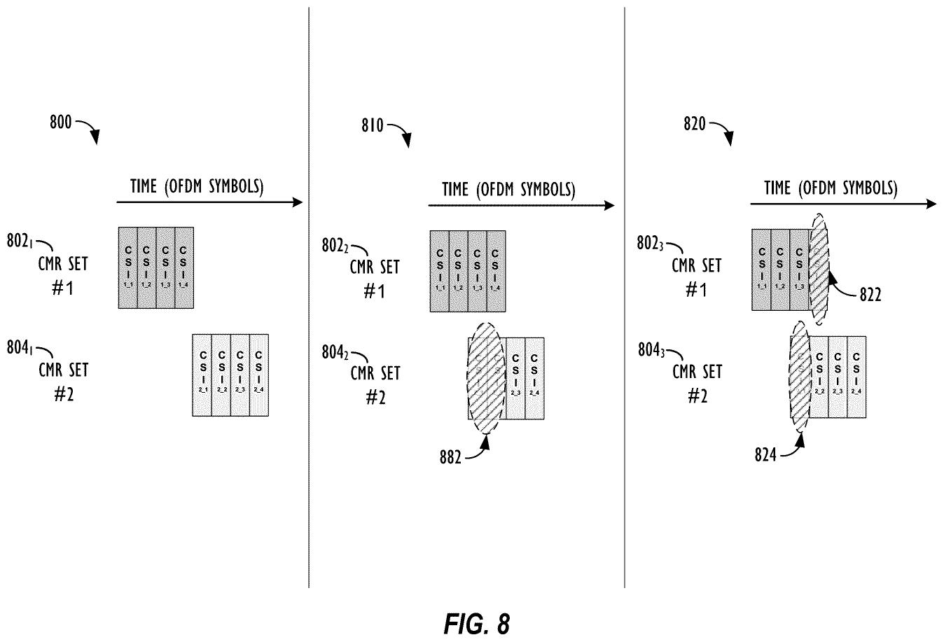

Referring next to FIG. 8, various diagrams 800/810/820 detailing methods of performing group-based beam reporting of partially overlapping CSI-RS L1 measurements with improved measurement delays are illustrated, according to some aspects. According to diagram 800, a “non-overlapping” CSI-RS embodiment is first illustrated, for comparison purposes. In particular, a first CMR set #1 (802₁), comprised of 4 CSI-RS resources (labeled as CSI_{1_1}, CSI_{1_2}, CSI_{1_3}, and CSI_{1_4}), is shown that does not overlap in the time domain with the resources of a second CMR set #2 (804₁), comprised of 4 CSI-RS resources (labeled as CSI_{2_1}, CSI_{2_2}, CSI_{2_3}, and CSI_{2_4}). In a case such as diagram 800, the equation used for the computation of the beam sweeping factor, N, may be: N=ceil(maxNumberRxBeam/K), where K is the number of CSI-RS in each CMR set, e.g., a value of K=4 would be used for the example shown in diagram 800.

However, according to diagram 810, there is an overlap of two OFDM symbols between a CMR set #1 (802₂), comprised of 4 CSI-RS resources (labeled as CSI_{1_1}, CSI_{1_2}, CSI_{1_3}, and CSI_{1_4}) and a CMR set #2 (804₂), also comprised of 4 CSI-RS resources (labeled as CSI_{2_1}, CSI_{2_2}, CSI_{2_3}, and CSI_{2_4}). In particular, the last two OFDM symbols of CMR set #1 (802₂), i.e., CSI_{1_3} and CSI_{1_4}, overlap in time with the first two OFDM symbols of CMR set #2 (804₂), i.e., CSI_{2_1} and CSI_{2_2}.

Thus, according to some embodiments, when there is overlap in time between the CMR sets, the computation of the value of N may be modified, such that N=ceil(maxNumberRxBeam/(K−X)), where X is the number of collided symbols. For example, in the case of diagram 810, X=2 for CMR set #2 (804₂), but X=0 for CMR set #2 (804₂). If there is full overlap in time between the two CMR sets, the equation for N reduces to N=2*ceil(maxNumberRxBeam/K).

According to still other embodiments, as is shown diagram 820, to reduce the overall measurement time when there is collision in time between at least some of the OFDM symbols of the CMR sets, the value of X can be set as ceil(the number of collided symbols/2). In other words, as shown in diagram 820, the two symbols in time that collide (i.e., CSI_{1_3} and CSI_{1_4} of CMR set #1 802₃ and CSI_{2_1} and CSI_{2_2} of CMR set #2 804₃) may be evenly divided, i.e., placing one collided symbol (i.e., CSI_{1_4}) in CMR set #1 804₃ and one collided symbol (i.e., CSI_{2_1}) in CMR set #2 804₃—rather than placing both collided symbols in CMR set #2, as in diagram 810. Since the overall measurement delay time is limited by the CMR set having the most collided symbols, it may reduce overall measurement time to divide the collided symbols as evenly as possible between the two CMR sets.

For the case of fully overlapping CMR sets, the two solutions presented in diagrams 810 and 820 may also be applied, i.e., a first solution (as in diagram 810) would be to measure one CMR set first in its entirety without measuring the other CMR set and then measuring the whole second CMR set in its entirety, and a second solution (as in diagram 820) would be to split the colliding symbols evenly. However, both solutions in the fully overlapping use case will lead to similar measurement times.

As may be appreciated, analogous schemes to the three alternative measurements schemes described and illustrated above with reference to FIGS. 7A-7C may likewise applied with CSI-RS measurement scheme embodiments having at least partial overlap between the CMR sets (e.g., as illustrated in diagrams 810 and 820).

### Network Configuration

As mentioned above, the various alternative measurements schemes described and illustrated above require different measurement times to complete. According to some embodiments, to provide maximum flexibility to both the network and the UE, the indication of which of the alternatives a UE supports can be reported as a UE capability. Further, the network can indicate which of the various alternative measurement schemes is configured to a particular UE, e.g., via radio resource configuration (RRC)/medium access control element (MAC CE)/downlink control information (DCI), or any other desired protocol.

### Exemplary Methods

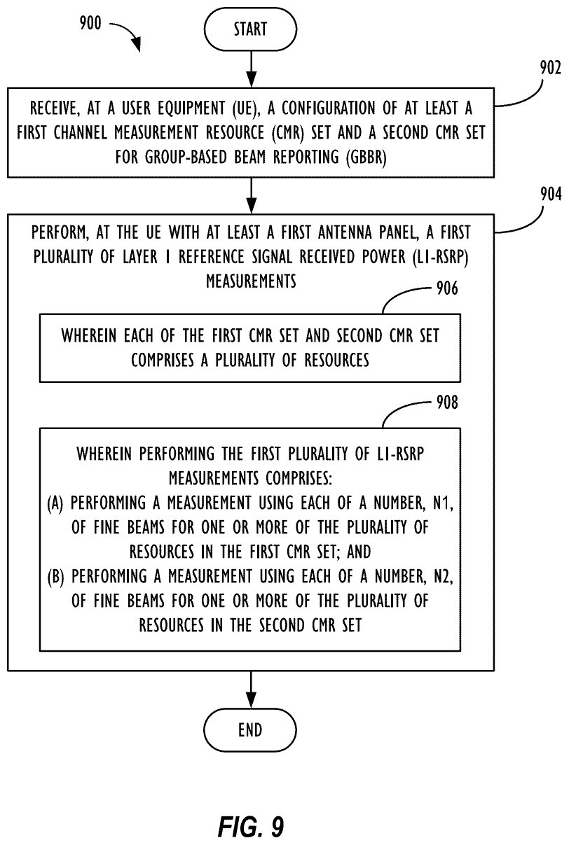

Turning now to FIG. 9, a flowchart 900 detailing a method of performing L1-RSRP measurements for group-based beam reporting is illustrated, according to some aspects. First, at block 902, a UE practicing the method of 900 may receive a configuration of at least a first Channel Measurement Resource (CMR) set and a second CMR set for group-based beam reporting.

Next, at block 904, the method 900 may perform, with at least a first antenna panel, a first plurality of Layer 1 Reference Signal Received Power (L1-RSRP) measurements. According to some aspects, each of the first CMR set and the second CMR set comprises a plurality of resources (e.g., Synchronization Signal Block (SSB) resources and/or Channel State Information Reference Signal (CSI-RS) resources) (block 906).

According to some aspects, performing the first plurality of L1-RSRP measurements comprises: (a) performing a measurement using each of a number, n1, of fine beams for one or more of the plurality of resources in the first CMR set; and (b) performing a measurement using each of a number, n2, of fine beams for one or more of the plurality of resources in the second CMR set (block 908).

As described above, in some embodiments (such as is illustrated in FIG. 7A), block 904 may comprise, for every SSB/CSI-RS period, testing a particular fine beam against each resource in each of a first and a second CMR set, which results in a longer measurement delay (i.e., one SSB/CSI-RS period for every resource in the first and second CMR sets) but the most comprehensive beam interference testing data. In other embodiments (such as is illustrated in FIG. 7B), block 904 may comprise, testing every resource in an SSB/CSI-RS period with a different fine beam, such that, after N SSB/CSI-RS periods, N different fine beams may have been tested against each resource of a first and a second CMR set, which results in a shorter measurement delay does not provide interference testing data. In still other embodiments, such as is illustrated in FIG. 7C), block 904 may comprise, a “hybrid” approach of testing some (but not all) of the fine beams against each resource in each of a first and a second CMR set, which results in an intermediate length measurement delay but also can provide beam interference testing data for particular beams of interest.

### Additional Comments

The use of the connective term “and/or” is meant to represent all possible alternatives of the conjunction “and” and the conjunction “or.” For example, the sentence “configuration of A and/or B” includes the meaning and of sentences “configuration of A and B” and “configuration of A or B.”

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method (e.g., any of a method aspects described herein, or, any combination of the method aspects described herein, or any subset of any of the method aspects described herein, or any combination of such subsets).

In some aspects, a device (e.g., a UE 106, a BS 102) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method of operating a user equipment (UE), the method comprising:
receiving, at the UE, a configuration of at least a first Channel Measurement Resource (CMR) set and a second CMR set for group-based beam reporting (GBBR); and
performing, at the UE with at least a first antenna panel, a first plurality of Layer 1 Reference Signal Received Power (L1-RSRP) measurements,
wherein each of the first CMR set and second CMR set comprises a plurality of resources, and
wherein performing the first plurality of L1-RSRP measurements comprises:
performing a measurement using each of a number, n1, of fine beams for one or more of the plurality of resources in the first CMR set; and
performing a measurement using each of a number, n2, of fine beams for one or more of the plurality of resources in the second CMR set.

2. The method of claim 1, wherein the first CMR set and second CMR set comprise Synchronization Signal Block (SSB) resource sets.

3. The method of claim 2, wherein the first CMR set and second CMR set are non-overlapping in time.

4. The method of claim 3, wherein performing the first plurality of L1-RSRP measurements further comprises:
performing a measurement using each of the n1 fine beams for each of the plurality of resources in the first CMR set; and
performing a measurement using each of the n2 fine beams for each of the plurality of resources in the second CMR set.

5. The method of claim 4, wherein the n1 fine beams are the same number of beams as the n2 fine beams.

6. The method of claim 3, wherein performing the first plurality of L1-RSRP measurements further comprises:
performing a measurement using each of the n1 fine beams for one of the resources in the first CMR set; and
performing a measurement using each of the n2 fine beams for one of the resources in the second CMR set.

7. The method of claim 6, further comprising:
for at least one of the n1 fine beams, performing a measurement using the at least one n1 fine beam for each of the resources in the second CMR set; and
for at least one of the n2 fine beams, performing a measurement using the at least one n2 fine beam for each of the resources in the first CMR set.

8. The method of claim 1, wherein the first CMR set and second CMR set comprise Channel State Information Reference Signal (CSI-RS) resource sets.

9. The method of claim 8, wherein the first CMR set and second CMR set are at least partially overlapping in time.

10. The method of claim 8, wherein the first CMR set and second CMR set are scheduled periodically or semi-persistently.

11. The method of claim 8, wherein performing the first plurality of L1-RSRP measurements further comprises:
performing a measurement using each of the n1 fine beams for each of the plurality of resources in the first CMR set; and
performing a measurement using each of the n2 fine beams for each of the plurality of resources in the second CMR set.

12. The method of claim 11, wherein the n1 fine beams are the same beams as the n2 fine beams.

13. The method of claim 8, wherein performing the first plurality of L1-RSRP measurements further comprises:
performing a measurement using each of the n1 fine beams for one of the resources in the first CMR set; and
performing a measurement using each of the n2 fine beams for one of the resources in the second CMR set.

14. The method of claim 9, wherein the values of n1 and n2 are determined based, at least in part, on a number of Orthogonal Frequency Division Multiplexing (OFDM) symbols that are overlapping in time between the first CMR set and the second CMR set.

15. The method of claim 14, wherein measurements are not performed in at least one of the first CMR set and the second CMR set during the OFDM symbols that are overlapping in time between the first CMR set and the second CMR set, and wherein the OFDM symbols overlapping in time between the first CMR set and the second CMR set during which measurements are not performed are evenly divided between the first CMR set and the second CMR set.

16. The method of claim 1, further comprising:
receiving, at the UE, a configuration from a network, wherein the configuration indicates a configuration for performing the first plurality of L1-RSRP measurements by the UE.

17. The method of claim 1, wherein each of n1 and n2 is less than or equal to a beam sweeping factor value, N.

18. The method of claim 1, wherein at least one of the first plurality of L1-RSRP measurements are performed with a second antenna panel.

19. A wireless device comprising:
a receiver;
a transmitter; and
a processor operably coupled to the receiver and transmitter, wherein the wireless device is configured to:
receive a configuration of at least a first Channel Measurement Resource (CMR) set and a second CMR set for group-based beam reporting (GBBR); and
perform, with at least a first antenna panel, a first plurality of Layer 1 Reference Signal Received Power (L1-RSRP) measurements,
wherein each of the first CMR set and second CMR set comprises a plurality of resources, and
wherein performing the first plurality of L1-RSRP measurements comprises:
performing a measurement using each of a number, n1, of fine beams for one or more of the plurality of resources in the first CMR set; and
perform a measurement using each of a number, n2, of fine beams for one or more of the plurality of resources in the second CMR set.

20. A baseband processor configured to cause a wireless device to:
receive a configuration of at least a first Channel Measurement Resource (CMR) set and a second CMR set for group-based beam reporting (GBBR); and
perform, with at least a first antenna panel, a first plurality of Layer 1 Reference Signal Received Power (L1-RSRP) measurements,
wherein each of the first CMR set and second CMR set comprises a plurality of resources, and
wherein performing the first plurality of L1-RSRP measurements comprises:
performing a measurement using each of a number, n1, of fine beams for one or more of the plurality of resources in the first CMR set; and
perform a measurement using each of a number, n2, of fine beams for one or more of the plurality of resources in the second CMR set.
